(19) United States
(12) Patent Application Publication
(10) Pub. No.: US 2025/0373104 A1
(43) Pub. Date: Dec. 4, 2025

(54) STATOR, MOTOR, AND METHOD OF MANUFACTURING STATOR

(71) Applicant: EXEDY Corporation, Osaka (JP)

(72) Inventor: Kengo MIYAKE, Osaka (JP)

(21) Appl. No.: 19/195,814

(22) Filed: May 1, 2025

(30) Foreign Application Priority Data
May 30, 2024 (JP) 2024-087977

(51) Int. Cl. H02K 3/28; H02K 1/16; H02K 3/18; H02K 15/026; H02K 15/095; H02K 15/33

(52) U.S. Cl. CPC H02K 3/28; H02K 1/16; H02K 3/18; H02K 15/026; H02K 15/095; H02K 15/33

(57) ABSTRACT

It is intended to prevent a space for forming coils from being reduced in dimension. A first coil includes a first wound wire portion and a second wound wire portion. The second wound wire portion is disposed on or radially outside the first wound wire portion. A second coil includes a third wound wire portion and a fourth wound wire portion. The fourth wound wire portion is disposed on or radially outside the third wound wire portion. A connecting portion includes a first link wire and a second link wire. The first link wire connects the first and third wound wire portions therethrough to each other. The second link wire connects the second and fourth wound wire portions therethrough to each other. The second link wire is disposed radially outside the first link wire.

### CROSS-REFERENCE TO RELATED APPLICATIONS

This application is based on and claims the priority benefit of application No. 2024-087977 filed on May 30, 2024, the contents of which are incorporated herein by reference.

### TECHNICAL FIELD

The claimed invention relates to a stator, a motor, and a method of manufacturing the stator.

### BACKGROUND

A motor includes a stator and a rotor. When the motor is of an outer rotor type, the rotor is disposed radially outside the stator. The stator includes a stator yoke, a plurality of teeth, and a plurality of coils (e.g., Japan Laid-open Patent Application Publication No. 2024-040760). The teeth extend radially outward from the stator yoke. The coils are wound about the teeth, respectively.

A slot, which is a gap between adjacent teeth, has a larger space on the outer peripheral side than on the inner peripheral side. Because of this, winding each coil about each tooth starts on the inner peripheral end of each tooth and ends on the outer peripheral end thereof.

Such a type of stator as described above has chances that a pair of coils is formed on a pair of teeth adjacent to each other, respectively, by a string of wire dedicated for winding. In this case, a link wire extends to connect the pair of coils. Winding each coil about each tooth starts on the inner peripheral end of each tooth and ends on the outer peripheral end thereof; hence, the link wire extends from the outer peripheral end of one of the pair of teeth to the inner peripheral end of the other of the pair of teeth. Thus, the link wire obliquely extends; hence, a large space is occupied by the link wire. When it is attempted to avoid interference between the pair of coils and the link wire, a drawback is caused that a space for forming the pair of coils is reduced in dimension.

### SUMMARY OF THE INVENTION

It is an object of the claimed invention to prevent a space for forming coils from being reduced in dimension.

A stator according to a first aspect includes a stator yoke, a first tooth, a second tooth, a first coil, a second coil, and a connecting portion. The stator yoke has a cylindrical shape. The first tooth extends radially outward from the stator yoke. The second tooth extends radially outward from the stator yoke. The second tooth is adjacent to the first tooth. The first coil is attached to the first tooth. The second coil is attached to the second tooth. The connecting portion connects the first and second coils therethrough to each other. The first coil includes a first wound wire portion and a second wound wire portion. The second wound wire portion is disposed on or radially outside the first wound wire portion. The second coil includes a third wound wire portion and a fourth wound wire portion. The fourth wound wire portion is disposed on or radially outside the third wound wire portion. The connecting portion includes a first link wire and a second link wire. The first link wire connects the first and third wound wire portions therethrough to each other. The second link wire connects the second and fourth wound wire portions therethrough to each other. The second link wire is disposed radially outside the first link wire.

According to this configuration, the first coil is divided into the first and second wound wire portions, while the second coil is divided into the third and fourth wound wire portions. With the coil structures, a link wire extending from the first coil to the second coil is not required to be obliquely extended from the outer peripheral end of the first coil to the inner peripheral end of the second coil. Because of this, a coil region interfering with the link wire can be reduced in dimension, whereby it is made possible to prevent a space for forming the coils from being reduced in dimension. Besides, the first link wire is disposed radially inside the second link wire; hence, interfering with the first link wire can be prevented when forming the second and fourth wound wire portions.

A stator according to a second aspect relates to the stator according to the first aspect and is configured as follows. The first link wire tilts from the first wound wire portion to the third wound wire portion so as to extend to a first side in an axial direction. The second link wire tilts from the second wound wire portion to the fourth wound wire portion so as to extend to a second side in the axial direction.

A stator according to a third aspect relates to the stator according to the first or second aspect and is configured as follows. The second link wire tilts from the fourth wound wire portion to the second wound wire portion so as to approach to the first link wire.

A stator according to a fourth aspect relates to the stator according to any of the first to third aspects and is configured as follows. The second wound wire portion is disposed on the first wound wire portion. The fourth wound wire portion is disposed on the third wound wire portion.

A stator according to a fifth aspect relates to the stator according to any of the first to fourth aspects and is configured as follows. The second wound wire portion is disposed radially outside the first wound wire portion.

A stator according to a sixth aspect relates to the stator according to any of the first to fifth aspects and is configured as follows. The first, second, third, and fourth wound wire portions are formed by a string of winding-dedicated wire.

A stator according to a seventh aspect relates to the stator according to any of the first to sixth aspects and is configured as follows. The first and third wound wire portions are formed by a winding-dedicated wire different from a winding-dedicated wire used for forming the second and fourth wound wire portions.

A stator according to an eighth aspect relates to the stator according to the seventh aspect and is configured as follows. The winding-dedicated wire used for forming the second and fourth wound wire portions is smaller in diameter than the winding-dedicated wire used for forming the first and third wound wire portions.

A motor according to a ninth aspect includes the stator recited in any of the first to eighth aspects and a rotor. The rotor is disposed radially outside the stator.

A method according to a tenth aspect relates to a method of manufacturing a stator. The method includes first to fifth steps as follows. In the first step, a stator core, including a first tooth and a second tooth adjacent to the first tooth, is prepared. In the second step, a first wound wire portion is formed on the first tooth. In the third step, a third wound wire portion is formed on the second tooth after forming the first wound wire portion. In the fourth step, a fourth wound wire portion is formed on the second tooth after forming the third wound wire portion. In the fifth step, a second wound wire portion is formed on the first tooth after forming the fourth wound wire portion. The first and third wound wire portions are connected to each other through a first link wire, while the second and fourth wire portions are connected to each other through a second link wire; besides, the second link wire is disposed radially outside the first link wire.

A method according to an eleventh aspect relates to a method of manufacturing a stator. The method includes first to seventh steps as follows. In the first step, a stator core, including a first tooth, a second tooth adjacent to the first tooth, and a third tooth, is prepared. In the second step, a first wound wire portion is formed on the first tooth. In the third step, a third wound wire portion is formed on the second tooth after forming the first wound wire portion. In the fourth step, a fifth wound wire portion is formed on the third tooth after forming the third wound wire portion. In the fifth step, a second wound wire portion is formed on the first tooth after forming the fifth wound wire portion. In the sixth step, a fourth wound wire portion is formed on the second tooth after forming the second wound wire portion. In the seventh step, a sixth wound wire portion is formed on the third tooth after forming the fourth wound wire portion. The first and third wound wire portions are connected to each other through a first link wire, while the second and fourth wound wire portions are connected to each other through a second link wire; besides, the second link wire is disposed radially outside the first link wire. The third and fifth wound wire portions are connected to each other through a third link wire, while the fourth and sixth wound wire portions are connected to each other through a fourth link wire; besides, the fourth link wire is disposed radially outside the third link wire.

A method according to a twelfth aspect relates to the method according to the tenth or eleventh aspect and further includes the steps of cutting the first link wire and cutting the second link wire.

Overall, according to the claimed invention, it is made possible to reliably produce a space for forming coils.

### BRIEF DESCRIPTION OF THE DRAWINGS

FIG. 1 is a front view of an embodiment of a motor in accordance with the claimed invention.

FIG. 2 is an enlarged front view of a stator used in the embodiment shown in FIG. 1.

FIG. 3 is an enlarged cross-sectional view of a portion of the stator.

FIG. 4 is a perspective view of a first wound wire portion, a third wound wire portion, and a fifth wound wire portion.

FIG. 5 is a perspective view of a second wound wire portion, a fourth wound wire portion, and a sixth wound wire portion.

FIG. 6 is a perspective view of a first coil, a second coil, and a third coil.

FIG. 7 is an enlarged cross-sectional view of a portion of a stator according to a modified embodiment.

FIG. 8 is an enlarged cross-sectional view of a portion of a stator according to another modified embodiment.

FIG. 9 is an enlarged cross-sectional view of a portion of a stator according to yet another modified embodiment.

FIG. 10 is an enlarged cross-sectional view of a portion of a stator according to the yet another modified embodiment.

FIG. 11 is an enlarged front view of a portion of a stator according to still yet another modified embodiment.

### DETAILED DESCRIPTION

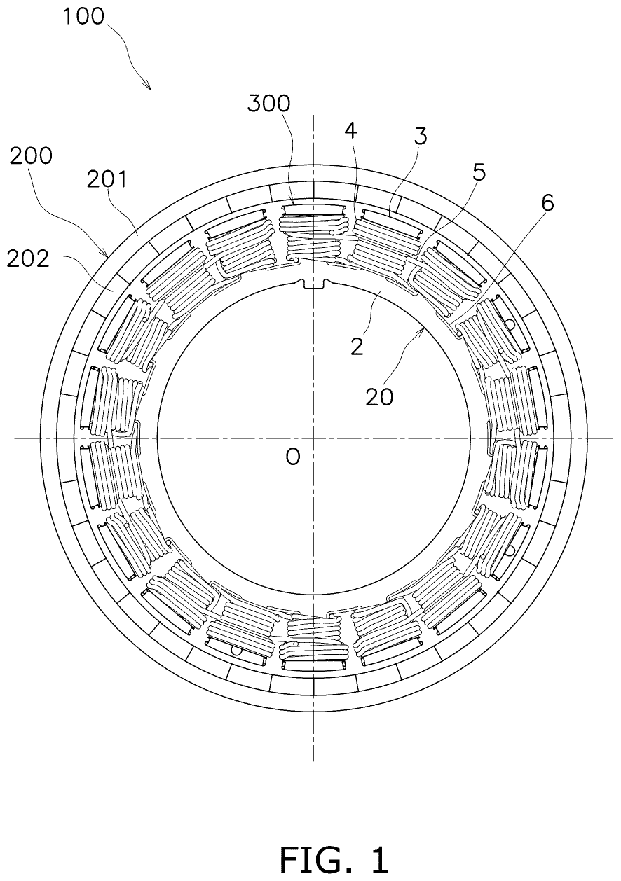

A stator 300, a motor 100, and a method of manufacturing the stator 300 according to the presently preferred embodiment will be hereinafter explained with reference to drawings. It should be noted that in the following explanation, the term “axial direction” refers to an extending direction of a rotational axis O of the motor 100. In other words, the term “axial direction” refers to the center axis of the stator 300. The term “first side in the axial direction” means the near side in the drawings of FIGS. 1 to 3, whereas the term “second side in the axial direction” means the far side in the drawings of FIGS. 1 to 3. In other words, the first side in the axial direction is opposite to the second side in the axial direction. On the other hand, the term “circumferential direction” refers to a circumferential direction of an imaginary circle about the rotational axis O, whereas the term “radial direction” refers to a radial direction of the imaginary circle about the rotational axis O. Yet on the other hand, the term “inner peripheral end” refers to one of both radial ends of each member, which is located close to the rotational axis O, whereas the term “outer peripheral end” refers to the other of both radial ends of each member, which is located far from the rotational axis O.

### <Motor>

As shown in FIG. 1, the motor 100 includes a rotor 200 and the stator 300. The rotor 200 is disposed radially outside the stator 300. In other words, the motor 100 is of an outer rotor type.

### <Rotor>

The rotor 200 includes a rotor yoke 201 and a plurality of permanent magnets 202. The rotor yoke 201 has a cylindrical shape. The permanent magnets 202 are fixed to the inner peripheral surface of the rotor yoke 201. The rotor 200 is configured to be rotated about the rotational axis O.

### <Stator>

The stator 300 includes a stator yoke 2, a plurality of teeth 3, a plurality of coils 4, and a plurality of connecting portions 5. It should be noted that the stator yoke 2 and the teeth 3 compose a stator core 20. The stator yoke 2 and the teeth 3 are provided to be integrated with each other. The stator core 20 is formed by laminating a plurality of sheets of electromagnetic steel plates as a plurality of layers. The stator 300 is non-rotatable. The center axis of the stator 300 is matched with the rotational axis O.

The stator yoke 2 has a cylindrical shape. The center axis of the stator yoke 2 is matched with the rotational axis O. The teeth 3 extend radially outward from the stator yoke 2. The teeth 3 are disposed away from each other at intervals in the circumferential direction. An insulator 6 is disposed to cover the outer peripheral surface of each tooth 3 and that of the stator yoke 2.

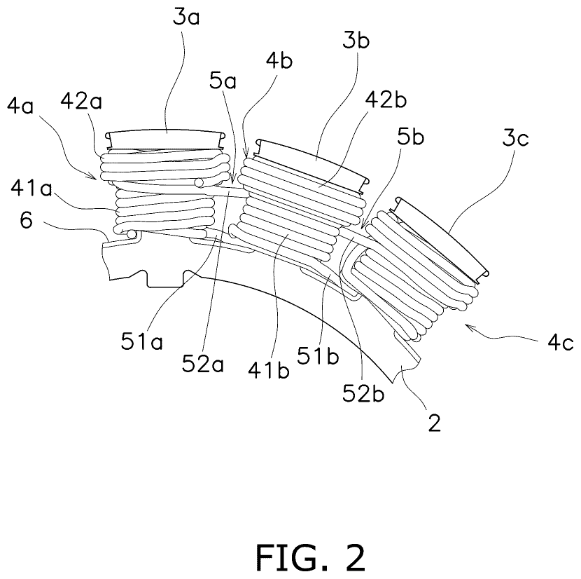

As shown in FIG. 2, the teeth 3 include a first tooth 3a and a second tooth 3b. The first and second teeth 3a and 3b are adjacent to each other in the circumferential direction. Besides, the teeth 3 include a third tooth 3c. The third tooth 3c is disposed adjacent to the second tooth 3b.

The coils 4 include a first coil 4a and a second coil 4b. The first coil 4a is attached to the first tooth 3a. The second coil 4b is attached to the second tooth 3b. Besides, the coils 4 include a third coil 4c. The third coil 4c is attached to the third tooth 3c. Each coil 4 is formed by winding a wire dedicated for winding (winding-dedicated wire) about each tooth 3. The winding-dedicated wire is wound about each tooth 3 by flyer winding. Because of this, each adjacent pair of coils 4 is required to be spaced away from each other at a distance identical in dimension to the diameter of the winding-dedicated wire.

The connecting portions 5 include a first connecting portion 5a (exemplary connecting portion). The first connecting portion 5a connects the first and second coils 4a and 4b therethrough to each other. Besides, the connecting portions 5 include a second connecting portion 5b. The second connecting portion 5b connects the second and third coils 4b and 4c therethrough to each other. It should be noted that likewise, each of the remaining connecting portions 5 connects relevant adjacent coils 4 therethrough to each other. Thus, the first, second, and third coils 4a, 4b, and 4c connected to each other form, for instance, a U-phase coil.

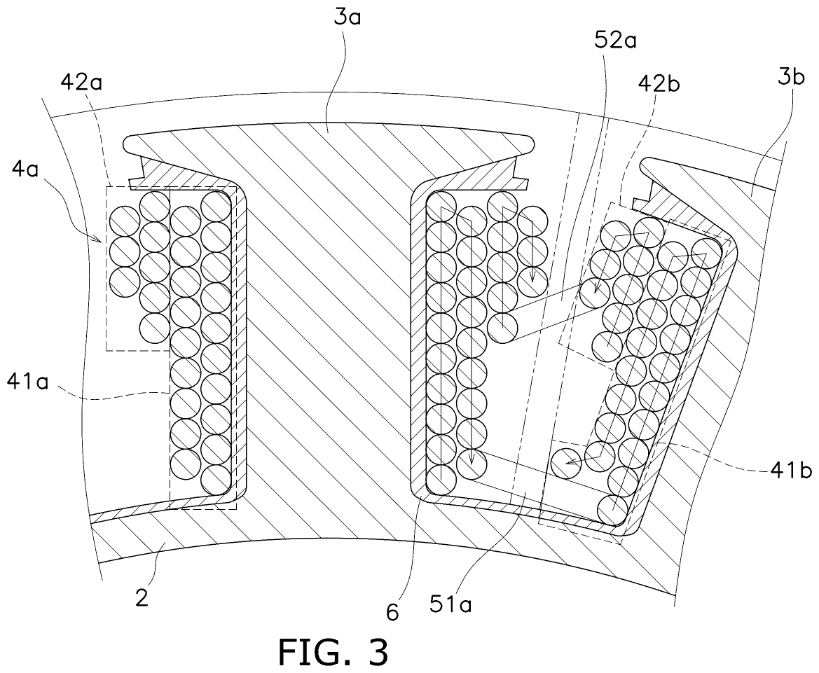

FIG. 3 is an enlarged cross-sectional view of the stator 300. As shown in FIG. 3, the first coil 4a includes a first wound wire portion 41a and a second wound wire portion 42a. The first wound wire portion 41a is wound about the first tooth 3a. The first wound wire portion 41a is made in the shape of a tube extending in the radial direction.

In the presently preferred embodiment, the first wound wire portion 41a is composed of two layers formed by the winding-dedicated wire. Specifically, the first wound wire portion 41a is composed of a first layer formed by winding the winding-dedicated wire onto the insulator 6 disposed on the outer peripheral surface of the first tooth 3a and a second layer formed by winding the winding-dedicated wire onto the first layer. The first wound wire portion 41a is formed by the winding-dedicated wire continuously wound thereabout without any link wires.

The second wound wire portion 42a is disposed on the first wound wire portion 41a. When the first wound wire portion 41a is herein divided into an inner peripheral part and an outer peripheral part in the radial direction, the second wound wire portion 42a is disposed on the outer peripheral part of the first wound wire portion 41a. The second wound wire portion 42a is connected to the first wound wire portion 41a through the second coil 4b. When described in detail, the second wound wire portion 42a is connected to the first wound wire portion 41a through the second and third coils 4b and 4c. In other words, the second wound wire portion 42a is not directly connected to the first wound wire portion 41a. The second wound wire portion 42a is formed by the winding-dedicated wire continuously wound thereabout without any link wires.

As shown in FIGS. 2 and 3, the second coil 4b includes a third wound wire portion 41b and a fourth wound wire portion 42b. The third wound wire portion 41b is wound onto the second tooth 3b. The third wound wire portion 41b is made in the shape of a tube extending in the radial direction.

In the presently preferred embodiment, the third wound wire portion 41b is composed of two layers formed by the winding-dedicated wire in a manner comparable to the first wound wire portion 41a. Specifically, the third wound wire portion 41b is composed of a first layer formed by winding the winding-dedicated wire onto the insulator 6 disposed on the outer peripheral surface of the second tooth 3b and a second layer formed by winding the winding-dedicated wire onto the first layer. The third wound wire portion 41b is formed by the winding-dedicated wire continuously wound thereabout without any link wires.

The fourth wound wire portion 42b is disposed on the third wound wire portion 41b. Besides, when the third wound wire portion 41b is divided into an inner peripheral part and an outer peripheral part in the radial direction, the fourth wound wire portion 42b is disposed on the outer peripheral part of the third wound wire portion 41b. The fourth wound wire portion 42b is connected to the third wound wire portion 41b through the third coil 4c. In other words, the fourth wound wire portion 42b is not directly connected to the third wound wire portion 41b. The fourth wound wire portion 42b is formed by the winding-dedicated wire continuously wound thereabout without any link wires.

The first connecting portion 5a includes a first link wire 51a and a second link wire 52b. The first link wire 51a connects the first and third wound wire portions 41a and 41b therethrough to each other. The first link wire 51a extends from the inner peripheral end of the first wound wire portion 41a to that of the third wound wire portion 41b. It should be noted that the inner peripheral end of the first wound wire portion 41a refers to the rotational axis O-side one of both radial ends of the first wound wire portion 41a. Likewise, the inner peripheral end of the third wound wire portion 41b refers to the rotational axis O-side one of both radial ends of the third wound wire portion 41b.

The second link wire 52a connects the second and fourth wound wire portions 42a and 42b therethrough to each other. The second link wire 52a extends from the inner peripheral end of the second wound wire portion 42a to that of the fourth wound wire portion 42b. It should be noted that the inner peripheral end of the second wound wire portion 42a refers to the rotational axis O-side one of both radial ends of the second wound wire portion 42a. Likewise, the inner peripheral end of the fourth wound wire portion 42b refers to the rotational axis O-side one of both radial ends of the fourth wound wire portion 42b.

The second link wire 52a is disposed radially outside the first link wire 51a. The first link wire 51a tilts from the first wound wire portion 41a to the third wound wire portion 41b so as to extend to the first side in the axial direction. On the other hand, the second link wire 52a tilts from the second wound wire portion 42a to the fourth wound wire portion 42b so as to extend to the second side in the axial direction. In other words, the first and second link wires 51a and 52a tilt to the opposite sides from each other.

The second link wire 52a tilts from the fourth wound wire portion 42b toward the second wound wire portion 42a to approach to the first link wire 51a. In other words, the second link wire 52a tilts radially inward from the fourth wound wire portion 42b to the second wound wire portion 42a.

The first link wire 51a tilts from the first wound wire portion 41a to the third wound wire portion 41b to separate from the second link wire 52a. In other words, the first link wire 51a tilts radially inward from the first wound wire portion 41a to the third wound wire portion 41b.

The first, second, third, and fourth wound wire portions 41a, 42a, 41b, and 42b are formed by a string of winding-dedicated wire. In other words, the first and second coils 4a and 4b are formed by the string of winding-dedicated wire. It should be noted that in the presently preferred embodiment, the first coil 4a, the second coil 4b, and the third coil 4c adjacent to the second coil 4b are formed by the string of winding-dedicated wire.

### <Method of Manufacturing Stator>

First, the stator core 20 is prepared that includes the first and second teeth 3a and 3b. Then, the first wound wire portion 41a is formed on the first tooth 3a by a flyer winding machine. When described in detail, the first layer of the first wound wire portion 41a is formed by winding the winding-dedicated wire from the inner peripheral end of the first tooth 3a to the outer peripheral end thereof in an order indicated by arrow in FIG. 3. Subsequently, the second layer of the first wound wire portion 41a is formed by winding the winding-dedicated wire from the outer peripheral end of the first tooth 3a to the inner peripheral end thereof on the first layer of the first wound wire portion 41a. Accordingly, the first wound wire portion 41a is formed on the first tooth 3a.

Next, the third wound wire portion 41b is formed on the second tooth 3b by the winding-dedicated wire used for forming the first wound wire portion 41a. When described in detail, the first link wire 51a is extended from the inner peripheral end of the first wound wire portion 41a to that of the second tooth 3b. Then, the first layer of the third wound wire portion 41b is formed by winding the winding-dedicated wire from the inner peripheral end of the second tooth 3b to the outer peripheral end thereof in an order indicated by arrow in FIG. 3. Subsequently, the second layer of the third wound wire portion 41b is formed on the first layer of the third wound wire portion 41b by winding the winding-dedicated wire from the outer peripheral end of the second tooth 3b to the inner peripheral end thereof. Accordingly, the third wound wire portion 41b is formed on the second tooth 3b. It should be noted that the wound direction of the third wound wire portion 41b is reverse of that of the first wound wire portion 41a. In the presently preferred embodiment, when seen from radially outside, the first wound wire portion 41a is wound clockwise, whereas the third wound wire portion 41b is wound counterclockwise.

Next, the third coil 4c is formed on the third tooth 3c adjacent to the second tooth 3b by the winding-dedicated wire used for forming the third wound wire portion 41b. When described in detail, the third coil 4c includes a fifth wound wire portion 41c and a sixth wound wire portion 42c in a manner comparable to the first coil 4a and the second coil 4b. Besides, the third coil 4c is connected to the second coil 4b through the second connecting portion 5b. The second connecting portion 5b includes a third link wire 51b and a fourth link wire 52b.

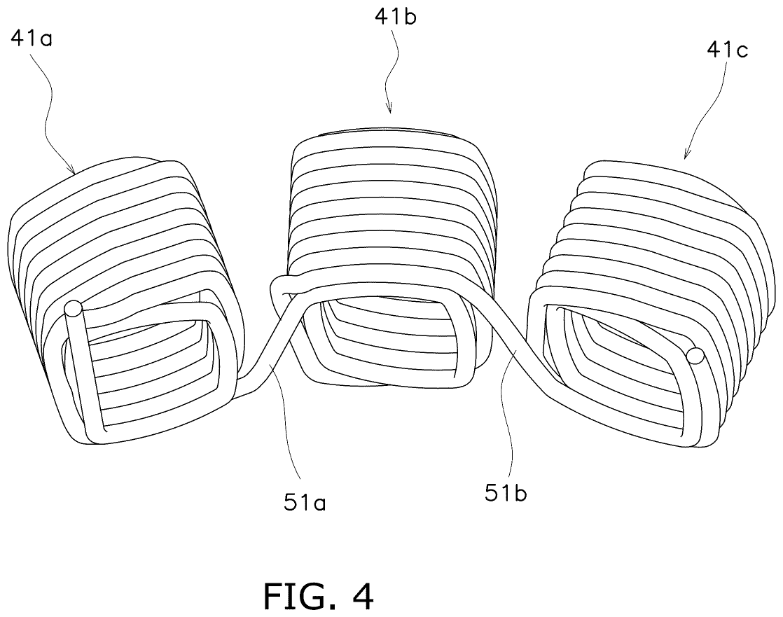

First, the fifth wound wire portion 41c is formed on the third tooth 3c. Specifically, the third link wire 51b is extended from the inner peripheral end of the third wound wire portion 41b to that of the third tooth 3c. Then, the first layer of the fifth wound wire portion 41c is formed by winding the winding-dedicated wire from the inner peripheral end of the third tooth 3c to the outer peripheral end thereof. Subsequently, the second layer of the fifth wound wire portion 41c is formed on the first layer by winding the winding-dedicated wire from the outer peripheral end of the third tooth 3c to the inner peripheral end thereof. It should be noted that the wound direction of the fifth wound wire portion 41c is reverse of that of the third wound wire portion 41b. In the presently preferred embodiment, when seen radially outside, the fifth wound wire portion 41c is wound clockwise. Thus, the first, third, and fifth wound wire portions 41a, 41b, and 41c are formed as shown in FIG. 4. It should be noted that FIG. 4 is a perspective view of the first, third, and fifth wound wire portions 41a, 41b, and 41c.

Next, the sixth wound wire portion 42c is formed on the fifth wound wire portion 41c. Specifically, the first layer of the sixth wound wire portion 42c is formed by winding the winding-dedicated wire from a middle part of the third tooth 3c to the outer peripheral end thereof; then, the second layer of the sixth wound wire portion 42c is formed on the first layer by winding the winding-dedicated wire from the outer peripheral end of the third tooth 3c to the middle part thereof. It should be noted that the sixth wound wire portion 42c is identical in wound direction to the fifth wound wire portion 41c. Accordingly, the sixth wound wire portion 42c is formed on the fifth wound wire portion 41c, whereby the third coil 4c is completed.

Next, the fourth wound wire portion 42b is formed on the second tooth 3b by the winding-dedicated wire used for forming the third coil 4c. When described in detail, the fourth link wire 52b is extended from the middle part of the third coil 4c to that of the third wound wire portion 41b. The fourth link wire 52b is disposed radially outside the third link wire 51b. Then, the first layer of the fourth wound wire portion 42b is formed on the third wound wire portion 41b by winding the winding-dedicated wire from the middle part of the second tooth 3b to the outer peripheral end thereof in the order indicated by arrow in FIG. 3. Subsequently, the second layer of the fourth wound wire portion 42b is formed on the first layer thereof by winding the winding-dedicated wire from the outer peripheral end of the second tooth 3b to the middle part thereof. It should be noted that the fourth wound wire portion 42b is identical in wound direction to the third wound wire portion 41b. Accordingly, the fourth wound wire portion 42b is formed on the third wound wire portion 41b, whereby the second coil 4b is completed.

Next, the second wound wire portion 42a is formed on the first tooth 3a by the winding-dedicated wire used for forming the second coil 4b. When described in detail, the second link wire 52a is extended from the inner peripheral end of the fourth wound wire portion 42b (the middle part of the second coil 4b) to the middle part of the first wound wire portion 41a. The second link wire 52a is disposed radially outside the first link wire 51a. Then, the first layer of the second wound wire portion 42a is formed on the first wound wire portion 41a by winding the winding-dedicated wire from the middle part of the first tooth 3a to the outer peripheral end thereof in an order indicated by arrow in FIG. 3.

Subsequently, the second layer of the second wound wire portion 42a is formed on the first layer thereof by winding the winding-dedicated wire from the outer peripheral end of the first tooth 3a to the middle part thereof. It should be noted that the second wound wire portion 42a is identical in wound direction to the first wound wire portion 41a. Accordingly, the second wound wire portion 42a is formed on the first wound wire portion 41a, whereby the first coil 4a is completed.

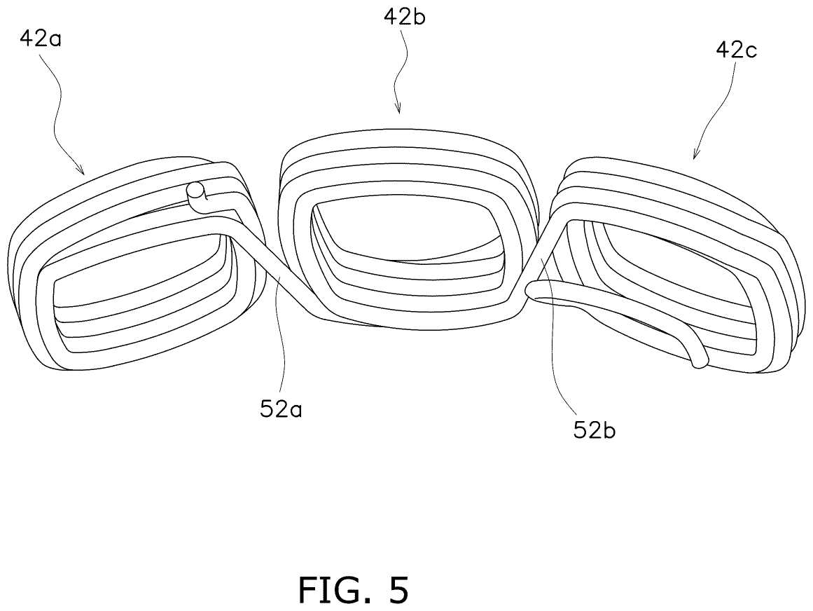

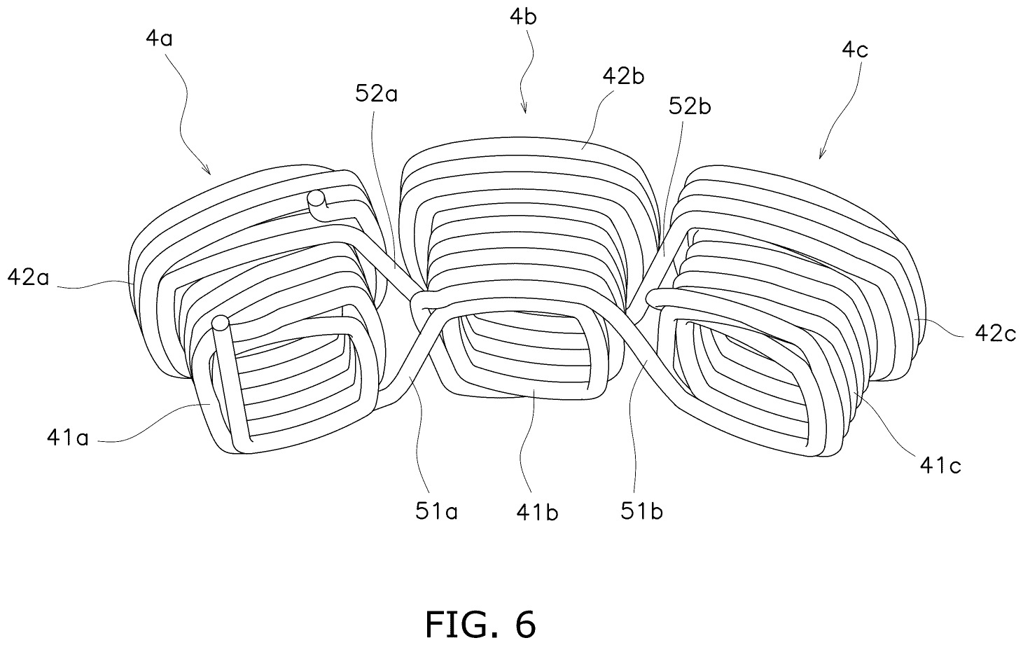

FIG. 5 shows a perspective view of the second, fourth, and sixth wound wire portions 42a, 42b, and 42c formed as described above, whereas FIG. 6 shows a perspective view of the first, second, and third coils 4a, 4b, and 4c.

As shown in FIGS. 4 to 6, the first coil 4a is divided into the first and second wound wire portions 41a and 42a, while the second coil 4b is divided into the third and fourth wound wire portions 41b and 42b. Then, the first wound wire portion 41a, the third wound wire portion 41b, the fourth wound wire portion 42b, and the second wound wire portion 42a are formed in this order. The second link wire 52a, extending from the fourth wound wire portion 42b to the second wound wire portion 42a, is disposed radially outside the first link wire 51a extending from the first wound wire portion 41a to the third wound wire portion 41b.

### Modifications

One preferred embodiment of the claimed invention has been explained above. However, the claimed invention is not limited to the above, and a variety of changes can be made without departing from the gist of the claimed invention. It should be noted that, basically speaking, respective modifications to be described are applicable simultaneously.

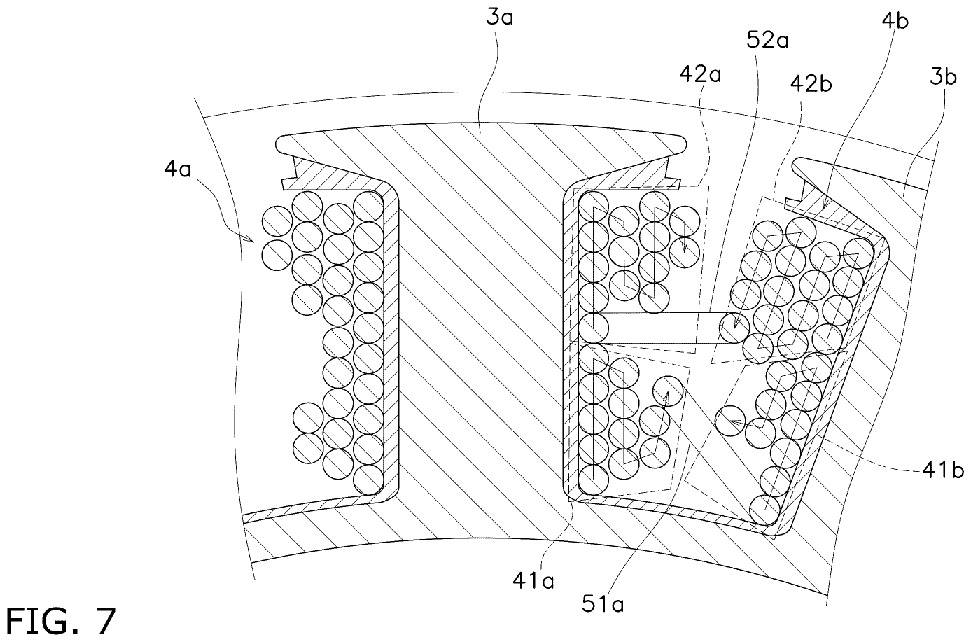

(a) As shown in FIG. 7, the second wound wire portion 42a may be disposed radially outside the first wound wire portion 41a. Likewise, the fourth wound wire portion 42b may be disposed radially outside the third wound wire portion 41b.

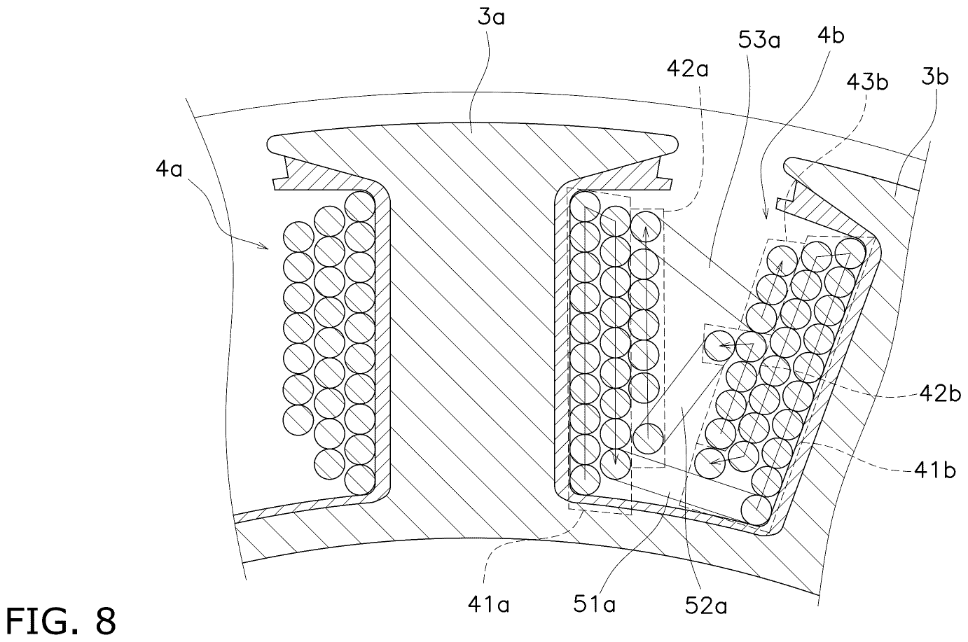

(b) In the preferred embodiment described above, the first coil 4a is composed of the first and second wound wire portions 41a and 42a, while the second coil 4b is composed of the third and fourth wound wire portions 41b and 42b. However, the first and second coils 4a and 4b are not limited in configuration to this. For example, as shown in FIG. 8, the second coil 4b may further include a seventh wound wire portion 43b in addition to the third and fourth wound wire portions 41b and 42b. The seventh wound wire portion 43b may be disposed on or radially outside the fourth wound wire portion 42b.

In this case, the first connecting portion 5a further includes a fifth link wire 53a in addition to the first and second link wires 51a and 52a. The fifth link wire 53a connects the second and seventh wound wire portions 42a and 43b therethrough to each other. The fifth link wire 53a is disposed radially outside the second link wire 52a. It should be noted that likewise, the first coil 4a may further include another wound wire portion in addition to the first and second wound wire portions 41a and 42a.

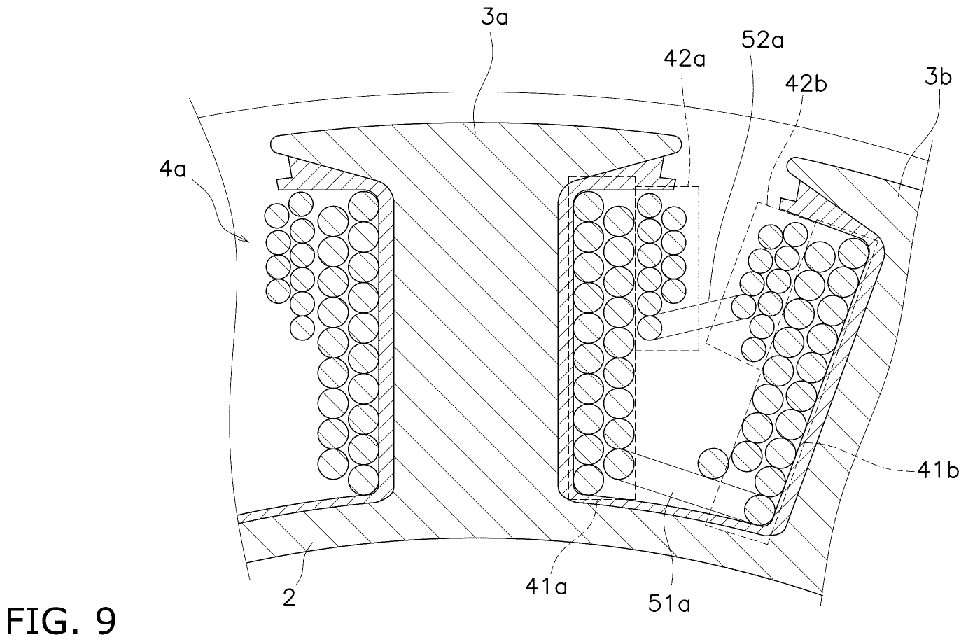

(c) As shown in FIG. 9, the winding-dedicated wire used for forming the first and third wound wire portions 41a and 41b may be different from that used for forming the second and fourth wound wire portions 42a and 42b. This configuration makes it possible to set the winding-dedicated wire used for forming the second and fourth wound wire portions 42a and 42b to be smaller in diameter than that used for forming the first and third wound wire portions 41a and 41b. Accordingly, it is made possible to set the distance between the first and second coils 4a and 4b to be smaller in dimension than the diameter of the winding-dedicated wire used for forming the first and third wound wire portions 41a and 41b. Besides, the winding-dedicated wire used for forming the first and third wound wire portions 41a and 41b and that used for forming the second and fourth wound wire portions 42a and 42b can be connected to each other in a conductive manner.

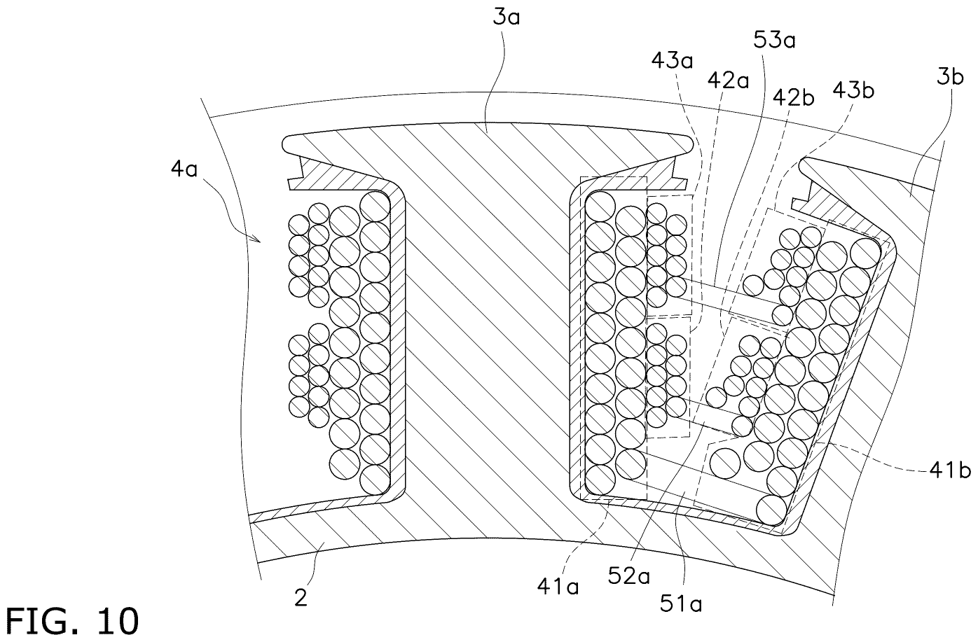

It should be noted that, when reduced in diameter, the winding-dedicated wire used for forming the second and fourth wound wire portions 42a and 42b is made small in cross-sectional area and is thereby lowered in allowable current. Because of this, as shown in FIG. 10, for instance, the first coil 4a may further include an eighth wound wire portion 43a, while the second coil 4b may further include the seventh wound wire portion 43b. The seventh and eighth wound wire portions 43b and 43a are formed by a winding-dedicated wire different from that used for forming the second and fourth wound wire portions 42a and 42b. Then, the winding-dedicated wire used for forming the seventh and eighth wound wire portions 43b and 43a and that used for forming the second and fourth wound wire portions 42a and 42b are connected in parallel to each other. The sum of the cross-sectional areas of the winding-dedicated wire used for forming the seventh and eighth wound wire portions 43b and 43a and that used for forming the second and fourth wound wire portions 42a and 42b is set to be comparable to or greater than the cross-sectional area of the winding-dedicated wire used for forming the first and third wound wire portions 41a and 41b, whereby allowable current can be prevented from being lowered.

(d) In the preferred embodiment described above, the first, second, and third coils 4a, 4b, and 4c are formed by the string of winding-dedicated wire, whereby the first, second, and third coils 4a, 4b, and 4c are connected to each other; however, the stator 300 is not limited in configuration to this. For example, after the first and second coils 4a and 4b are formed, the first and second link wires 51a and 52a may be cut. Likewise, after the second and third coils 4b and 4c are formed, the third and fourth link wires 51b and 52b may be cut. Accordingly, for instance, the first coil 4a can be made in the form of a U-phase coil, whereas the second coil 4b can be made in the form of a V-phase coil.

(e) The third tooth 3c may not be adjacent to the second tooth 3b. In other words, at least one tooth 3 may be disposed between the second and third teeth 3b and 3c. In this case, the third coil 4c is not adjacent to the second coil 4b as well. In other words, at least one coil 4 is disposed between the second and third coils 4b and 4c.

(f) In the preferred embodiment described above, the first and second coils 4a and 4b are connected to the third coil 4c; however, the stator 300 is not limited in configuration to this. For example, the first and second coils 4a and 4b may not be connected to the third coil 4c. In other words, the stator 300 may not include the second connecting portion 5b. In this case, the fourth wound wire portion 42b is directly connected to the third wound wire portion 41b.

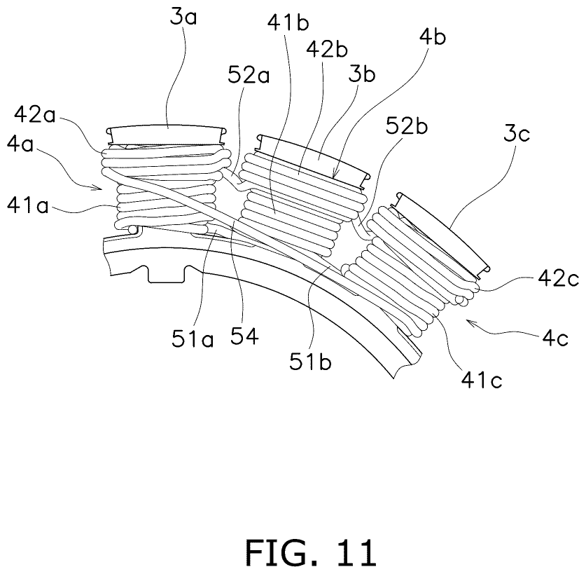

(g) In the preferred embodiment described above, the first to sixth wound wire portions are formed in the order of the first wound wire portion 41a, the third wound wire portion 41b, the fifth wound wire portion 41c, the sixth wound wire portion 42c, the fourth wound wire portion 42b, and the second wound wire portion 42a; however, the order of forming the first to sixth wound wire portions is not limited to this. For example, as shown in FIG. 11, the first to sixth wound wire portions may be formed in the order of the first wound wire portion 41a, the third wound wire portion 41b, the fifth wound wire portion 41c, the second wound wire portion 42a, the fourth wound wire portion 42b, and the sixth wound wire portion 42c. In this case, the stator 300 includes a link wire 54 extending from the fifth wound wire portion 41c to the second wound wire portion 42a. For example, the link wire 54 is extended on the coil end side. In other words, the link wire 54 is disposed on the first or second side of the coils 4a to 4c in the axial direction.

In this modification, the first and second link wires 51a and 52a tilt from the first coil 4a to the second coil 4b so as to extend to the first side in the axial direction. In other words, the first and second link wires 51a and 52a are identical in tilt direction to each other. Besides, the third and fourth link wires 51b and 52b tilt from the second coil 4b to the third coil 4c so as to extend to the second side in the axial direction. In other words, the third and fourth link wires 51b and 52b are identical in tilt direction to each other.

### LIST OF REFERENCE NUMERALS

2: Stator yoke, 3a: First tooth, 3b: Second tooth, 4a: First coil, 41a: First wound wire portion, 42a: Second wound wire portion, 4b: Second coil, 41b: Third wound wire portion, 42b: Fourth wound wire portion, 5a: First connecting portion, 51a: First link wire, 52a: Second link wire, 20: Stator core, 100: Motor, 200: Rotor, 300: Stator

1. A stator, comprising:
a stator yoke having a cylindrical shape;
a first tooth extending radially outward from the stator yoke;
a second tooth extending radially outward from the stator yoke, the second tooth adjacent to the first tooth;
a first coil attached to the first tooth;
a second coil attached to the second tooth; and
a connecting portion connecting the first and second coils therethrough to each other, whereby
the first coil includes
a first wound wire portion, and
a second wound wire portion disposed on or radially outside the first wound wire portion,
the second coil includes
a third wound wire portion, and
a fourth wound wire portion disposed on or radially outside the third wound wire portion, and
the connecting portion includes
a first link wire connecting the first and third wound wire portions therethrough to each other, and
a second link wire connecting the second and fourth wound wire portions therethrough to each other, the second link wire disposed radially outside the first link wire.

2. The stator according to claim 1, wherein
the first link wire tilts from the first wound wire portion to the third wound wire portion so as to extend to a first side in an axial direction, and
the second link wire tilts from the second wound wire portion to the fourth wound wire portion so as to extend to a second side in the axial direction.

3. The stator according to claim 1, wherein the second link wire tilts from the fourth wound wire portion to the second wound wire portion so as to approach to the first link wire.

4. The stator according to claim 1, wherein
the second wound wire portion is disposed on the first wound wire portion, and
the fourth wound wire portion is disposed on the third wound wire portion.

5. The stator according to claim 1, wherein the second wound wire portion is disposed radially outside the first wound wire portion.

6. The stator according to claim 1, wherein the first, second, third, and fourth wound wire portions are formed by a string of winding-dedicated wire.

7. The stator according to claim 1, wherein the first and third wound wire portions are formed by a winding-dedicated wire different from a winding-dedicated wire used for forming the second and fourth wound wire portions.

8. The stator according to claim 7, wherein the winding-dedicated wire used for forming the second and fourth wound wire portions is smaller in diameter than the winding-dedicated wire used for forming the first and third wound wire portions.

9. A motor, comprising:
the stator recited in claim 1; and
a rotor disposed radially outside the stator.

10. A method of manufacturing a stator, the method comprising the steps of:
preparing a stator core including a first tooth and a second tooth adjacent to the first tooth;
forming a first wound wire portion on the first tooth;
forming a third wound wire portion on the second tooth after forming the first wound wire portion;
forming a fourth wound wire portion on the second tooth after forming the third wound wire portion; and
forming a second wound wire portion on the first tooth after forming the fourth wound wire portion, wherein
the first and third wound wire portions are connected to each other through a first link wire, the second and fourth wire portions connected to each other through a second link wire, the second link wire disposed radially outside the first link wire.

11. A method of manufacturing a stator, the method comprising the steps of:
preparing a stator core including a first tooth, a second tooth adjacent to the first tooth, and a third tooth;
forming a first wound wire portion on the first tooth;
forming a third wound wire portion on the second tooth after forming the first wound wire portion;
forming a fifth wound wire portion on the third tooth after forming the third wound wire portion;
forming a second wound wire portion on the first tooth after forming the fifth wound wire portion;
forming a fourth wound wire portion on the second tooth after forming the second wound wire portion; and
forming a sixth wound wire portion on the third tooth after forming the fourth wound wire portion, wherein
the first and third wound wire portions are connected to each other through a first link wire, the second and fourth wound wire portions connected to each other through a second link wire, the second link wire disposed radially outside the first link wire, and
the third and fifth wound wire portions are connected to each other through a third link wire, the fourth and sixth wound wire portions connected to each other through a fourth link wire, the fourth link wire disposed radially outside the third link wire.

12. The method according to claim 10, further comprising the steps of:
cutting the first link wire; and
cutting the second link wire.
